(19) United States
(12) Patent Application Publication
(10) Pub. No.: US 2023/0192133 A1
(43) Pub. Date: Jun. 22, 2023

(54) CONDITIONAL MODE ANCHORING

(71) Applicant: GM CRUISE HOLDINGS LLC, San Francisco, CA (US)

(72) Inventors: Abbas Shikari, San Francisco, CA (US); Adam Abdulhamid, San Francisco, CA (US)

(21) Appl. No.: 17/557,878

(22) Filed: Dec. 21, 2021

(51) Int. Cl. B60W 60/00; G01C 21/36; G06V 20/58

(52) U.S. Cl. CPC B60W 60/0015; G01C 21/3605; G06V 20/58; B60W 2420/42; B60W 2554/4049

(57) ABSTRACT

The subject disclosure relates to techniques for providing a condition into a path prediction model that results in the path prediction model providing an object path prediction corresponding to the condition that, if not for the condition, the object path prediction would not be output by the path prediction model. A process of the disclosed technology can include inputting at least one condition of interest into the path prediction model, inputting features descriptive of an environment and objects in the environment into the path prediction model, and receiving multiple predicted paths for the specific object from the path prediction model. The multiple predicted paths can include at least one predicted path that corresponds to the at least one condition that, if not for the at least one condition, the path prediction model would not output the at least one predicted path that corresponds to the at least one condition.

### BACKGROUND

### 1. Technical Field

The subject technology pertains to training a path prediction model to receive at least one condition into the path prediction model and to provide an object path prediction corresponding to the at least one condition, and in particular, the subject technology pertains to anchoring a path prediction with conditions of interest to cause the path prediction model to output paths corresponding to the conditions of interest even if the probability of their occurrence is beneath a threshold to be output by the path prediction model.

### 2. Introduction

Prediction is important to help autonomous vehicles operate efficiently. Typically, prediction models will output one or more of the most likely outcomes or predictions. However, in some scenarios, the path of interest could be unlikely.

### BRIEF DESCRIPTION OF THE DRAWINGS

FIG. 1 illustrates an example of a system for managing one or more Autonomous Vehicles (AVs) in accordance with some aspects of the present technology.

FIG. 2A illustrates an example environment having an autonomous vehicle and objects in accordance with some aspects of the present technology.

FIG. 2B illustrates an example environment having an autonomous vehicle and objects in accordance with some aspects of the present technology.

FIG. 3 is a flowchart of a method for conditional mode anchoring in accordance with some aspects of the present technology.

FIG. 4 is a flowchart of a method for training a model for conditional mode anchoring in accordance with some aspects of the present technology.

FIG. 5 shows an example of a system for implementing certain aspects of the present technology.

### DETAILED DESCRIPTION

Prediction is important to help autonomous vehicles (AV) operate efficiently. AVs need an idea of where other objects are and the likely paths that the objects might follow to operate efficiently and safely.

Typically, prediction models will output one or more of the most likely outcomes as a prediction. However, in some scenarios, the most likely outcomes might not include an actual outcome when the actual outcome is seen as unlikely. In some examples, these unlikely trajectories may result in severe outcomes. Thus, there is a need in the art for identifying and predicting these unlikely yet potentially severe trajectories even though they are unlikely to occur.

One benefit of providing the multiple predicted paths and their respective probabilities of occurrence to the AV planning algorithm 118 is that the AV 102 can appropriately plan for a variety of occurrences. For example, it is useful for the AV 102 to be aware of the most probable paths an object will take, and it is useful for the AV to be aware of even a small change that an object might take a path that would cause a collision too. As such the present technology provides a benefit to the planning stack 118 to plan a course based on probable paths taken by objects, but to also include the chances of other low probability events as well. Such combined set of factors might, for example, cause the AV 102 to plan the same course, but at a slower speed so that the AV can better react to the low probability event if it were to happen.

The present technology is a result of the conception of the benefit of providing low probability, but highly consequential paths to the AV planning stack. At the same time, the present technology also recognizes the constraints on available compute power of the planning stack, and the need for fast outputs from the planning stack. Accordingly, it is not desirable to simply output all possible predictions of the predication stack because each prediction still needs to be consumed and evaluated by the planning stack. Thus it is desirable to only provide predicted paths that are consequential in planning maneuvers for the AV.

Current prediction models suffer from a lack of mode diversity, where a mode is a group of predicted actions. Multimodal predictions that lack mode diversity produce a similar response in an autonomous vehicle to a unimodal model. Multimodality is one of the ways in which prediction can express uncertainty and provides the AV a mechanism to reason about different semantic behaviors that ultimately lead to safer and smoother driving behavior. While these models are often good, the current approach can be further improved.

In other words, there is a need in the art for encouraging diverse modes in prediction models while maintaining high mode quality. The present technology addresses the shortcomings of current prediction models. More specifically, the present technology introduces conditional anchoring of modes to find a better way to encourage diverse modes in the prediction models while maintaining high mode quality. For example, the present technology can input a specified mode or condition of interest to anchor the prediction model. The prediction model can then output predicted trajectories based on the specified mode or conditions of interest.

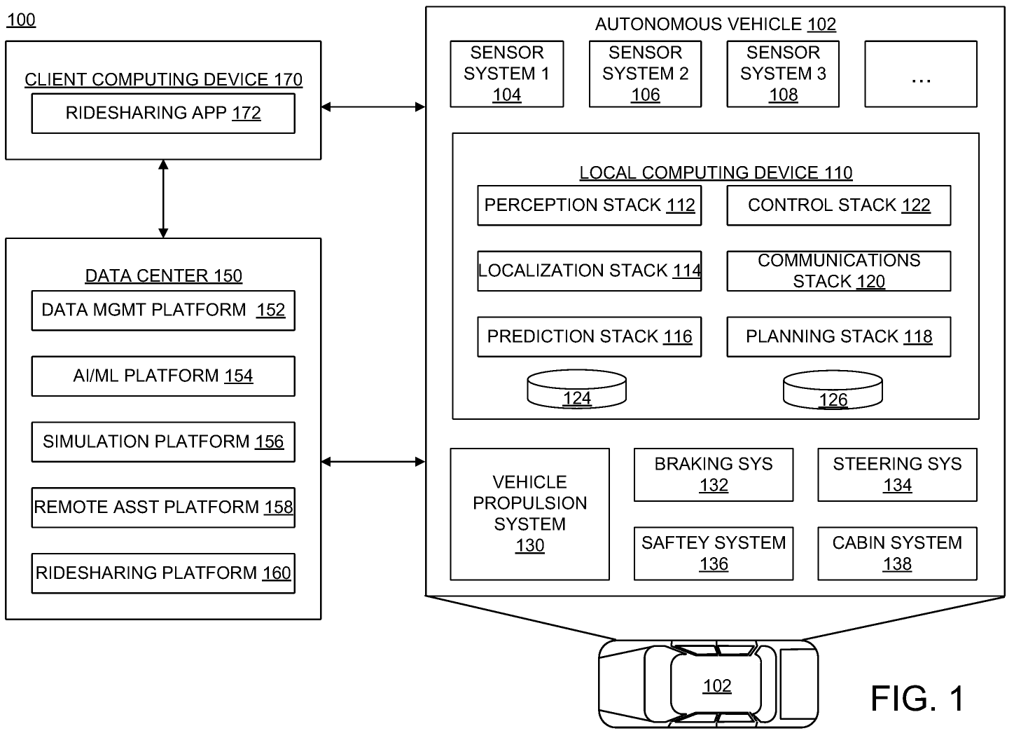

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., light detection and ranging (LIDAR) systems, ambient light sensors, infrared sensors, etc.), RADAR systems, global positioning system (GPS) receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some embodiments, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUls), etc.) for controlling certain aspects of the mechanical systems 130-138.

The AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV’s environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV’s position and orientation (pose) using different methods from multiple systems (e.g., GPS, IMUs, cameras, LIDAR, RADAR, ultrasonic sensors, the HD geospatial database 126, etc.). For example, in some embodiments, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some embodiments, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV’s steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate the local exchange of information, such as through a wired connection (e.g., a user’s mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112 – 122, and other components of the AV 102 and/or data received by the AV 102 from remote systems (e.g., the data center 150, the client computing device 170, etc.). In some embodiments, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can be a private cloud (e.g., an enterprise network, a co-location provider network, etc.), a public cloud (e.g., an laaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the cartography platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the cartography platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the cartography platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 172. The client computing device 170 can be a customer’s mobile computing device or a computing device integrated with the AV 102 (e.g., the local computing device 110). The ridesharing platform 160 can receive requests to pick up or drop off from the ridesharing application 172 and dispatch the AV 102 for the trip.

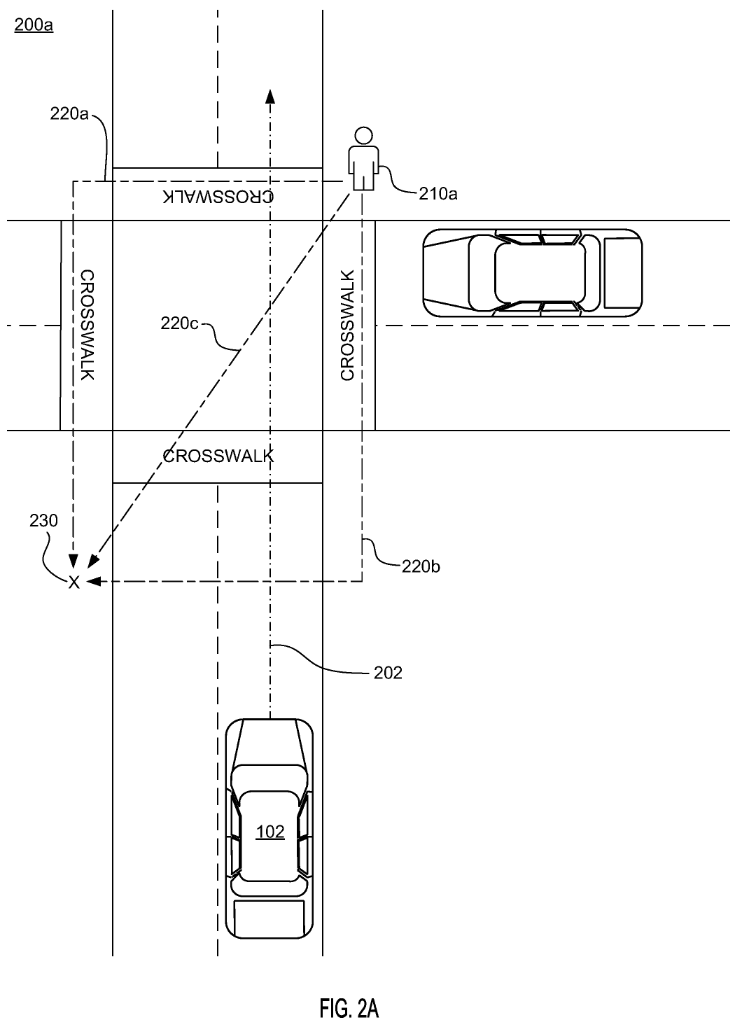

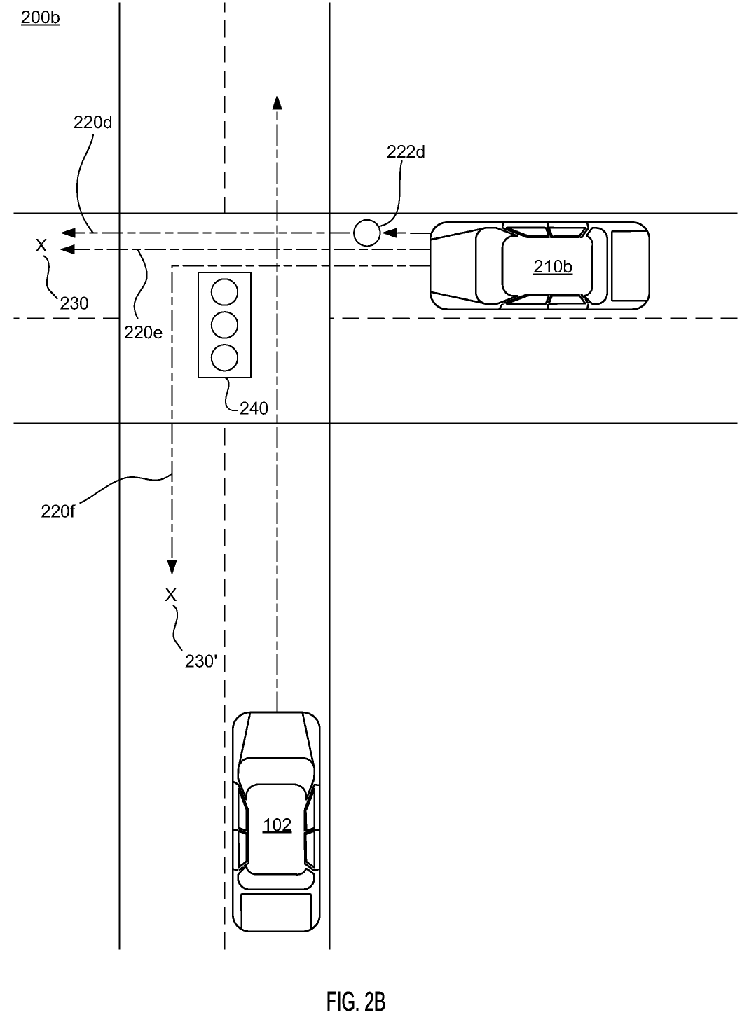

FIGS. 2A and 2B illustrate environments 200a, 200b that includes an autonomous vehicle 102 (e.g., AV 102 illustrated in FIG. 1) and objects 210a, 210b (collectively object(s) 210), which AV 102 can perceive, for example using sensor systems 104-108 and perception stack 112. Object 210 can be an object of interest or a specified as an object of interest in an environment and/or a simulated scene. For example, object 210 can be a pedestrian 210a as illustrated in FIG. 2A, another vehicle 210b as illustrated in FIG. 2B, a bicyclist, etc. Object 210 can have various potential trajectories or potential 220a, 220b, 220c, 220d, 220e, 220f (collectively potential paths 220 or predicted paths 220).

A path prediction model as part of the path prediction stack 116 can be on-board the AV 102 and/or accessed through a wireless connection (e.g., a wireless connection to and from data center 150 and/or client computing device 170). For example, path prediction model can be configured in AI/ML platform 154 and/or simulation platform 156 as discussed above with respect to FIG. 1.

FIG. 2A illustrates a pedestrian 210a trying to get to a possible destination 230. The path prediction model is configured to predict one or more of the potential paths 220 or predicted paths 220 based on contextual information or features 240 received from and/or perceived by AV 102. The path prediction model can predict multiple predicted paths 220 based on contextual information, such as availability of crosswalks. For example, the path prediction model can predict predicted path 220a, such that predicted path 220a is associated with pedestrian 210a utilizing crosswalks to cross both streets when permitted. The path prediction model can also predict predicted path 220b, such that predicted path 220b is associated with pedestrian 210a utilizing only one crosswalk to cross one street and jaywalking to cross another street. The path prediction model can also predict predicted path 220c, such that predicted path 220c is associated with pedestrian 210a utilizing no crosswalks to cross streets and instead jaywalking to cross both streets. As shown, predicted paths 220b, 220c are potential paths that can interfere with a path 202 of AV 102, which can have a severe outcome if the AV collides with the pedestrian. In some scenarios, certain features or contextual information may associate predicted paths 220b, 220c with low probabilities of occurring. For example, pedestrian 210a may be slowing down as pedestrian 210a reaches the crosswalks, and looks at a crosswalk signal, etc. Many path prediction models today may choose not to output these predicted paths in some of these scenarios due to the low probabilities falling below a threshold probability. However, the path prediction model disclosed herein can identify these low probability predicted paths and output these paths associated with potentially severe outcomes and their associated probabilities of occurring.

As another example, FIG. 2B illustrates vehicle 210b navigating along a street. As discussed above, the path prediction model can predict multiple predicted paths 220 based on features 240 (e.g., a stoplight). For example, the path prediction model can predict predicted path 220d, such that predicted path 220d is associated with vehicle 210b stopping at a spot 222d near the stoplight 240 before proceeding to possible destination 230 because the stoplight may be a red-light that is instructing vehicles to stop for that direction. The path prediction model can also predict predicted path 220e, such that predicted path 220e is associated with vehicle 210b running through a red light on stoplight 240 on the way to possible destination 230. The path prediction model can also predict predicted path 220f, such that predicted path 220f is associated with vehicle 210b running stop through a red light on stoplight 240 to make a left turn to get to a different possible destination 230′.

Furthermore, the path prediction model is configured to determine at least one condition of interest. A condition of interest can be an object (e.g., object 210) with a potential maneuver that could result in a path that would interfere with AV 102. For example, in FIG. 2B, the condition of interest can be vehicle 210b running through a red light on stoplight 240 to get to either possible destination 230, 230′, making an unprotected left turn, etc.

A condition of interest can also be an object (e.g., object 210) with a potential possible destination 230, 230′ that could result in a path that would interfere with AV 102. For example, in FIG. 2B, the condition of interest can be vehicle 210b navigating to either of possible locations 230, 230′. More specifically, the condition of interest can be vehicle 210b running through a red light on stoplight 240 to get to either possible destination 230, 230′.

The path prediction model can “anchor” path predictions based on features 240 and the condition of interest. In other words, the path prediction model can receive the condition of interest as an input to generate trajectories or potential paths for object 210, all of which include the condition of interest. In other words, the path prediction model can be configured to output predicted paths having an associated probability above a threshold probability and output predicted paths having an associated probability below the threshold probability but associated with the condition of interest. Thus, the path prediction model disclosed here can output predicted paths and associated probabilities that would not be outputted if not for the condition of interest.

For example, a vehicle running a red light is generally a low probability scenario, especially if the vehicle is observed slowing down as it approaches the red light. However, a vehicle running a red light can create a severe outcome. As discussed above, many path prediction models today may choose not to output predicted paths due to the low probabilities falling below a threshold probability. However, the path prediction model disclosed here can identify these low probability, but potentially severe outcome predicted paths and accordingly output them and their respective probabilities of occurring.

For example, the path prediction model takes vehicle 210b running through a red light on stoplight 240 as an input or condition of interest. The path prediction model can then predict and output multiple predicted paths (e.g., predicted paths 220e, 220f) for vehicle 210b. Thus, the prediction and outputting of predicted path 220e represents a predicted path having an associated probability below a threshold probability but associated with the condition of interest (e.g., running through a red light). Due to the associated probability being low, a path prediction model might be configured to output predicted paths 220e, 220f. However, the path prediction model described herein can identify these potentially dangerous scenarios so that AV 102 can react safely and efficiently. For example, the multiple predicted paths and their respective probabilities of occurrence could be provided into an AV planning algorithm or into planning stack 118 to maneuver or control AV 102 safely and efficiently.

As another example, if two cars approach an all-way stop intersection, the path prediction model can receive or be provided with an anchor for one of the two vehicles approaching the intersection that indicates that the vehicle is asserting right of way (e.g., by entering the intersection first), even if the vehicle does not have right of way or is entering the intersection out of turn or before the other vehicle. In other words, the path prediction model can receive interactions with other agents or objects in the environment as inputs or conditions of interests, such as a vehicle asserting right of way even when the vehicle does not have right of way.

In some embodiments, the path prediction model may also still predict and output a high probability trajectory (e.g., a trajectory or predicted path that is above a threshold value), such as predicted path 220d, which is associated with vehicle 210b stopping at the red light.

As another example, the path prediction model can receive vehicle 210b and possible destination 230 as inputs and output a trajectory of vehicle 210b based on features 240, vehicle 210b, contextual information of vehicle 210b (e.g., speed, acceleration, or deceleration, direction, turn signals, etc.) to generate both predicted paths 220d, 220e, but not predicted path 220f, which does not share the condition of interest (e.g., possible destination 230). Although it is to be understood that in some embodiments, the path prediction model can still output predicted path 220f (e.g., if the probability for predicted path 220f is above a threshold probability).

It is further considered that the path prediction model can be configured to receive a planned path of the AV 102 as an input and, based on the planned path input, provide any predicted paths that may interfere with the planned path of the AV 102. Additionally, it is also considered that the path prediction model is configured to output all possible paths for objects 210 and the probabilities of the respective paths occurring.

Additionally, current path prediction models may not be configured to receive conditions of interest to anchor outputs. Accordingly, the present disclosure additionally teaches a new model architecture to enable a path prediction model as described above.

A path prediction model, such as the path prediction model described herein, can be trained by conditioning the model on each conditional anchor. The conditional anchors can be a set of x,y points or coordinates, one-hot vector encoding each cluster, and/or learned representations (e.g., x,y points, vectors, etc.). It is to be understood, however, that conditional anchors can include various other methods that encapsulate the concept of specifying a maneuver. For example, the conditional anchors can additionally include heuristic modes that include at least 7 modes selected in a radial coordinate system as a function of angle and distance from a starting point: stationary (e.g., less than 1 meter traveled), straight slow (e.g., +/- 20-degree cone from straight AND less than 30 meters traveled), straight medium (e.g., +/-20-degree cone from straight AND less than 45 meters traveled), straight fast (e.g., +/- 20-degree cone from straight AND greater than or equal to 45 meters traveled), left (e.g., final point ends in 20 to 90-degree zone from origin), right (e.g., final point ends in -20 to -90 degree zone from origin), etc.

The path prediction model can generate one trajectory or predicted path for each conditional anchor during trajectory generation or path prediction, which can be interpreted as a conditional anchor “conditioned” on the input anchor. In some embodiments, this can be implemented as a batch operation, such that the same multilayered perceptron is computed on each conditioned feature. Additionally, a heuristic can select which predicted path to backpropagate. In some embodiments, the heuristic selects the top conditional anchor as a function of an actual trajectory.

In some embodiments, the path prediction model can process all possible trajectories or predicted paths of objects 210. The path prediction model can then take this set of predicted paths as an input to a classification portion of the path prediction model to produce a probability distribution over those predicted paths. Thus, the set of predicted paths can share network weights among all conditional anchors and provide loss for every example while also explicitly encouraging conditional anchor diversity via the anchoring mechanism.

More specifically, the classification portion of the path prediction model can associate conditional anchors with semantic anchors. The heuristics can select conditional anchors to be trained based on which semantic anchor an actual trajectory or path of the object belongs to.

As discussed above, the path prediction model can include a quantified uncertainty associated with a predicted path. In other words, each predicted path has an uncertainty that is associated therewith. The path prediction model can also associate an uncertainty to a particular conditional anchor during uncertainty calculation or computation.

An additional benefit of training the path prediction model as described above is that the model can result in better probability calibration, as it learns a full probability distribution over conditional anchors instead of learning part of the distribution and assuming a constant for the expected mode.

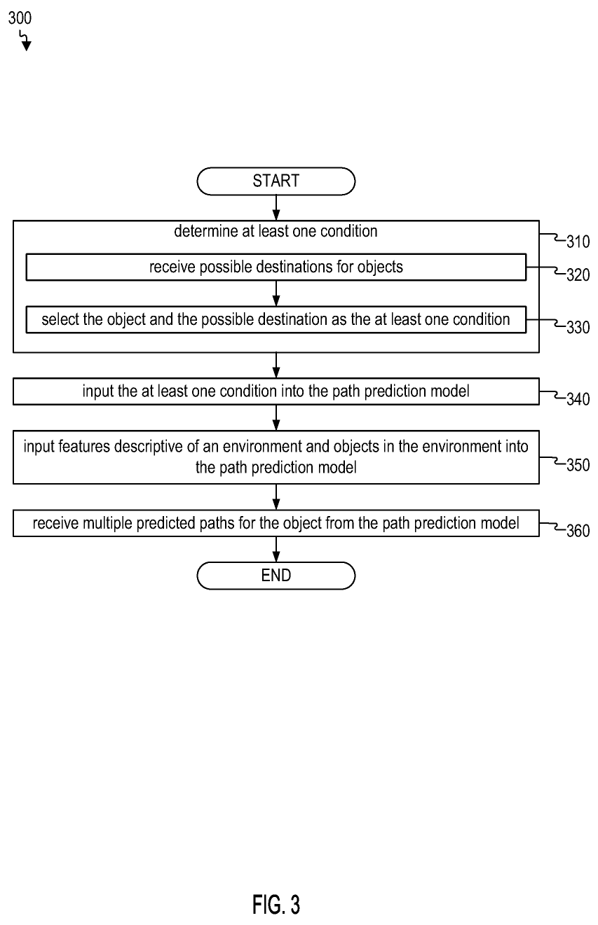

FIG. 3 illustrates an example method 300 for providing a condition into a path prediction model. More specifically, FIG. 3 illustrates an example method 300 for providing a condition into a path prediction model that results in the path prediction model providing an object path prediction corresponding to the condition that, if not for the condition, the path prediction model would not be output by the path prediction model. In other words, the example method 300 enables predicting paths using conditional anchors. Although example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

Example method 300 includes determining 310 at least one condition of interest. For example, prediction stack 116 illustrated in FIG. 1 may determine at least one condition of interest. In some embodiments, a condition of interest is an object with a destination that would result in a path that would interfere with an autonomous vehicle.

Example method 300 includes receiving 320 possible destinations for objects during a time interval from an object destination model that predicts the possible destinations for the objects during the time interval. For example, prediction stack 116 illustrated in FIG. 1 may receive possible destinations for objects during a time interval from an object destination model that predicts the possible destinations for the objects during the time interval.

Example method 300 includes selecting 330 the object and the possible destination for the object as the at least one condition of interest when the object would need to traverse a path that would interfere with the path of the autonomous vehicle. For example, prediction stack 116 illustrated in FIG. 1 may select the object and the possible destination for the object as the at least one condition of interest when the object would need to traverse a path that would interfere with the path of the autonomous vehicle.

In some embodiments, determining 310 the at least one condition of interest includes receiving 320 possible destinations and selecting 330 the object and the possible destination as the at least one condition of interest.

Example method 300 includes inputting 340 the at least one condition of interest into the path prediction model. For example, prediction stack 116 illustrated in FIG. 1 may input the at least one condition of interest into the path prediction model.

In some embodiments, the inputting of the at least one condition of interest further includes characterizing the object and a potential path of the object, the characterizing the object can include an identification of the object and its type, and characterizing its path can include a heading and a speed of travel. For example the heading of the object could be characterized as stationary (< 1.0 m traveled), straight slow (+ -20 degree cone from straight AND < 30 m traveled), straight medium (+ -20 degree cone from straight AND < 45 m traveled), straight fast (+ -20 degree cone from straight AND > = 45 m traveled), left (final point ends in 20 to 90 degree zone from origin), right (final point ends in -20 to -90 degree zone from origin), and all others.

In some embodiments, the potential path of the object can be a collection of X and Y coordinate points representing an approximate path.

In some embodiments, the potential path of the object is characterized by a destination region for the object. In some embodiments, the inputting of the at least one condition of interest further includes characterizing the object and a potential path of the object.

In some embodiments, the at least one condition of interest into the path prediction model includes multiple conditions of interest, and the multiple predicted paths for the object include at least one corresponding predicted path for each condition of interest that was input into the path prediction model.

Example method 300 includes inputting 350 features descriptive of an environment and objects in the environment into the path prediction model. For example, prediction stack 116 illustrated in FIG. 1 may input features descriptive of an environment and objects, including the object of interest, in the environment into the path prediction model.

Example method 300 includes receiving 360 multiple predicted paths for the object from the path prediction model, the multiple paths including at least one predicted path that corresponds to the condition that, if not for the condition, the path prediction model would not output the at least one predicted path that corresponds to the condition. For example, prediction stack 116 illustrated in FIG. 1 may receive multiple predicted paths for the object from the path prediction model. The multiple paths include at least one predicted path that corresponds to the condition that, if not for the condition, the path prediction model would not output the at least one predicted path that corresponds to the condition.

The path prediction model is configured to output any path that is associated with a probability of occurrence that is greater than a threshold probability. In some embodiments, the path prediction model is further configured to output a path that is below a threshold probability when the path matches a condition provided as an input to the path prediction model. The multiple predicted paths also include probable paths for the object, the probable paths being ones that the path prediction model would output without the condition. The path prediction model would not output the at least one predicted path that corresponds to the condition if not for the condition because the at least one predicted path is associated with a low probability of occurrence.

In some embodiments, the multiple predicted paths and their respective probability of occurrence is provided into a AV planning algorithm with their associated probabilities. One benefit of providing the multiple predicted paths and their respective probabilities of occurrence to the AV planning algorithm 118 is that the AV 102 can appropriately plan for a variety of occurrences. For example, it is useful for the AV 102 to be aware of the most probably paths an object will take, and it is useful for the AV to be aware of even a small change that an object might take a path that would cause a collision too. As such the present technology provides a benefit to the planning stack 118 to plan a course based on probable paths taken by objects, but to also include the chances of other low probability events as well. Such combined set of factors might, for example, cause the AV 102 to plan the same course, but at a slower speed so that the AV can better react to the low probability event if it were to happen.

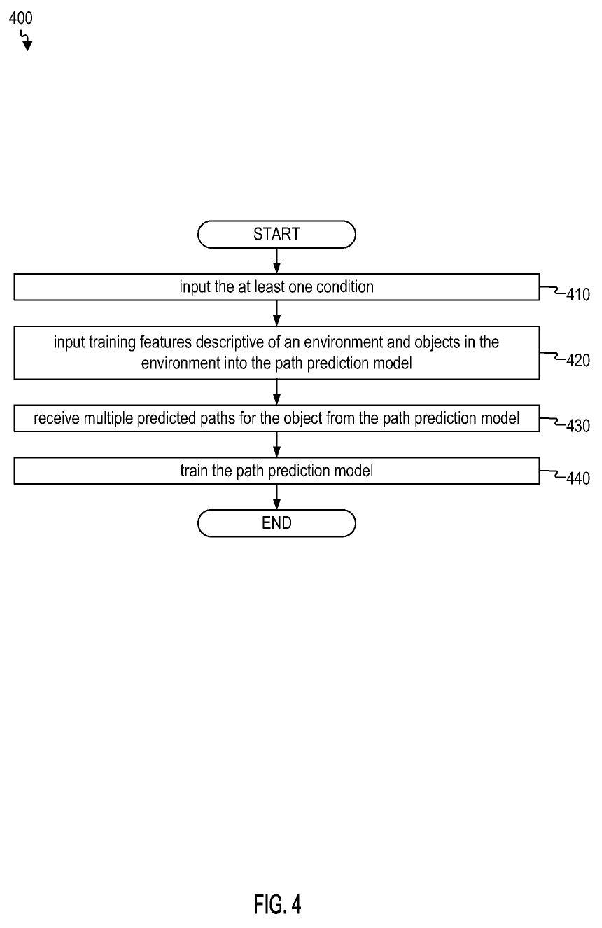

FIG. 4 illustrates an example method 400 for training a model. More specifically, FIG. 4 illustrates an example method 400 for training a path prediction model to receive at least one condition into the path prediction model and to provide an object path prediction corresponding to the condition. Thus, example method 400 enables predicting paths with conditional anchoring by utilizing a trained path prediction model. Although example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

Example method 400 includes inputting 410 the at least one condition of interest into the machine learning algorithm being trained to predict paths of objects, the at least one condition characterizing an object, and a potential path of the object. For example, AI/ML platform 154 illustrated in FIG. 1 may input the at least one condition of interest into a machine learning algorithm being trained to predict paths of objects. The at least one condition characterizes an object and a potential path of the object.

Example method 400 includes inputting 420 training features descriptive of an environment and objects in the environment into the machine learning algorithm being trained to predict paths of objects. For example, AI/ML platform 154 illustrated in FIG. 1 may input training features descriptive of an environment and objects in the environment into the machine learning algorithm being trained to predict paths of objects.

Example method 400 includes receiving 430 multiple predicted paths for the object from the machine learning algorithm being trained to predict paths of objects, the multiple paths including at least one predicted path that corresponds to the at least one condition. For example, AI/ML platform 154 illustrated in FIG. 1 may receive multiple predicted paths for the object from the machine learning algorithm being trained to predict paths of objects. The multiple paths include at least one predicted path that corresponds to the at least one condition.

Example method 400 includes training 440 the machine learning algorithm being trained to predict paths of objects to reinforce a first path from the multiple predicted paths that most closely matches an observed path for the object, and to reinforce the at least one predicted path that corresponds to the condition as being a valid possible conclusion given the at least one condition as an input. For example, AI/ML platform 154 illustrated in FIG. 1 may train the machine learning algorithm being trained to predict paths of objects to reinforce a first path from the multiple predicted paths that most closely matches an observed path for the object, and to reinforce the at least one predicted path that corresponds to the condition as be a valid possible conclusion given the at least one condition as an input.

In another example of the training 440 the machine learning algorithm being trained to predict paths of objects, example method 400 comprises analyzing the multiple predicted paths using a heuristic to identify paths that meet criteria specified by the condition. For example, AI/ML platform 154 illustrated in FIG. 1 may analyze the multiple predicted paths using a heuristic to identify paths that meet criteria specified by the condition. The identified paths that meet the criteria specified by the condition are the valid possible conclusions.

In another example of the training 440 the machine learning algorithm being trained to predict paths of objects, the method comprises comparing the multiple predicted paths received from the machine learning algorithm being trained to predict paths of objects in response to the input training features with the observed path that resulted from the input training features to identify the first path that most closely matches the observed path for the object. For example, AI/ML platform 154 illustrated in FIG. 1 may compare the multiple predicted paths received from the machine learning algorithm being trained to predict paths of objects in response to the input training features with the observed path that resulted from the input training features to identify the first path that most closely matches the observed path for the object. The reinforcement of the at least one predicted path that corresponds to the condition as being a valid possible conclusion given the condition as the input includes an identification of the condition for which the at least one predicted path is valid possible conclusion given the condition as the input.

The result of the training of the machine learning algorithm being trained to predict paths of objects can be a component of the prediction stack 116 on AV 102.

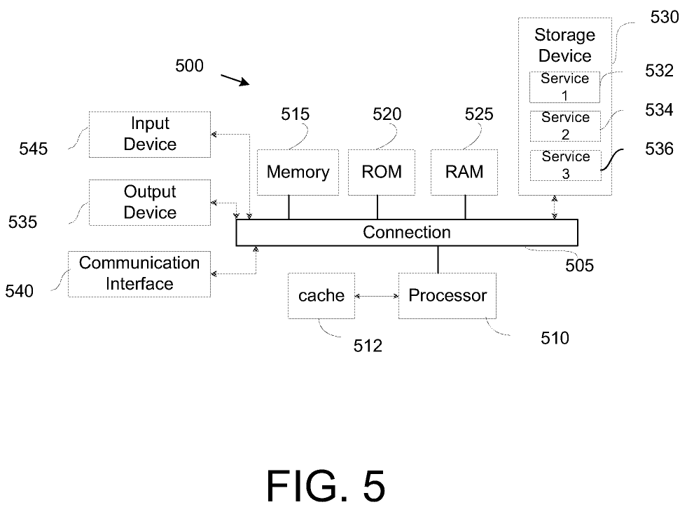

FIG. 5 shows an example of computing system 500, which can be for example any computing device making up local computing device 110, client computing device 170, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method comprising:
inputting at least one condition of interest into a path prediction model, the at least one condition characterizing a potential path of a specific object;
inputting features descriptive of an environment and objects in the environment into the path prediction model, the objects including the specific object; and
receiving multiple predicted paths for the specific object from the path prediction model, the multiple predicted paths including at least one predicted path that corresponds to the at least one condition that, if not for the at least one condition, the path prediction model would not output the at least one predicted path that corresponds to the at least one condition.

2. The method of claim 1, further comprising:
determining the at least one condition of interest, wherein a condition of interest is an object with a destination that would result in a path that would interfere with an autonomous vehicle.

3. The method of claim 2, wherein determining the at least one condition of interest further comprising:
receiving possible destinations for the objects during a time interval from an object destination model that predicts the possible destinations for the objects during the time interval; and
selecting the object as the specific object and the possible destination for the object as the at least one condition of interest when the object would need to traverse a path that would interfere with the autonomous vehicle.

4. The method of claim 1, wherein the inputting of the at least one condition of interest further includes characterizing the object and the potential path of the object, the characterizing the object includes an identification of the object and an associated type, and characterizing the potential path includes a heading a speed of travel.

5. The method of claim 1, wherein the path prediction model would not output the at least one predicted path that corresponds to the condition if not for the at least one condition because the at least one predicted path is associated with a low probability of occurrence.

6. The method of claim 1, wherein the path prediction model is configured to output any path that is associated with a probability of occurrence that is greater than a threshold probability.

7. The method of claim 6, wherein the path prediction model is further configured to output a path that is below the threshold probability when the path matches the at least one condition provided as an input to the path prediction model.

8. The method of claim 1, wherein the at least one condition of interest includes multiple conditions of interest, and the multiple predicted paths for the specific object includes at least one corresponding predicted path for each condition of interest that was input into the path prediction model.

9. A non-transitory computer readable medium comprising instructions, the instructions, when executed by a computing system, cause the computing system to:
input at least one condition of interest into a path prediction model, the at least one condition characterizing a potential path of a specific object;
input features descriptive of an environment and objects in the environment into the path prediction model, the objects including the specific object; and
receive multiple predicted paths for the specific object from the path prediction model, the multiple predicted paths including at least one predicted path that corresponds to the at least one condition that, if not for the at least one condition, the path prediction model would not output the at least one predicted path that corresponds to the at least one condition.

10. The computer readable medium of claim 9, wherein the computer readable medium further comprises instructions that, when executed by the computing system, cause the computing system to:
determine the at least one condition of interest, wherein a condition of interest is an object with a destination that would result in a path that would interfere with an autonomous vehicle.

11. The computer readable medium of claim 10, wherein the computer readable medium further comprises instructions that, when executed by the computing system, cause the computing system to:
receive possible destinations for the objects during a time interval from an object destination model that predicts the possible destinations for the objects during the time interval; and
select the object as the specific object and the possible destination for the object as the at least one condition of interest when the object would need to traverse a path that would interfere with the autonomous vehicle.

12. The computer readable medium of claim 9, the inputting of the at least one condition of interest further includes characterizing the object and the potential path of the object, the characterizing the object includes an identification of the object and an associated type, and characterizing the potential path includes a heading a speed of travel.

13. The computer readable medium of claim 9, the path prediction model would not output the at least one predicted path that corresponds to the condition if not for the at least one condition because the at least one predicted path is associated with a low probability of occurrence.

14. The computer readable medium of claim 9, the path prediction model is configured to output any path that is associated with a probability of occurrence that is greater than a threshold probability.

15. The computer readable medium of claim 14, the path prediction model is further configured to output a path that is below the threshold probability when the path matches the at least one condition provided as an input to the path prediction model.

16. The computer readable medium of claim 9, the at least one condition of interest includes multiple conditions of interest, and the multiple predicted paths for the specific object includes at least one corresponding predicted path for each condition of interest that was input into the path prediction model.

17. A method of training a path prediction model to receive at least one condition into the path prediction model and to provide an object path prediction corresponding to the at least one condition, the method comprising:
inputting the at least one condition of interest into the path prediction model, the at least one condition characterizing an object and a potential path of the object;
inputting training features descriptive of an environment and objects in the environment into the path prediction model, the objects including the object;
receiving multiple predicted paths for the object from the path prediction model, the multiple paths including at least one predicted path that corresponds to the at least one condition; and
training the path prediction model to reinforce a first path from the multiple predicted paths that most closely matches an observed path for the object, and to reinforce the at least one predicted path that corresponds to the condition as being a valid possible conclusion given the at least one condition as an input.

18. The method of claim 17, wherein the reinforcement of the at least one predicted path that corresponds to the condition as being a valid possible conclusion given the condition as the input, the method comprising:
analyzing the multiple predicted paths using a heuristic to identify paths that meet criteria specified by the condition, wherein the identified paths that meet the criteria specified by the condition are the valid possible conclusions.

19. The method of claim 17, wherein the reinforcement of the first path from the multiple predicted paths that most closely matches an observed path for the object further comprises:
comparing the multiple predicted paths received from the path prediction model in response to the input training features with the observed path that resulted from the input training features to identify the first path that most closely matches the observed path for the object.

20. The method of claim 19, wherein the reinforcement of the at least one predicted path that corresponds to the condition as being a valid possible conclusion given the condition as the input, includes an identification of the condition for which the at least one predicted path is valid possible conclusion given the condition as the input.
